(19) United States
(12) Patent Application Publication
(10) Pub. No.: US 2026/0307236 A1
(43) Pub. Date: Oct. 8, 2026

(54) SYSTEMS AND METHODS FOR A CASE ASSEMBLY FOR STORING TOOLS

(71) Applicant: Stanley Black & Decker MEA FZE, Dubai (AE)

(72) Inventors: Chin-Tzu HUANG, Taichung (TW); Hui-Ling TENG, Taichung (TW); Fu-Yao CHENG, Taipei (TW); Kai Xiang HSU, Taichung (TW)

(73) Assignee: Stanley Black & Decker MEA FZE, Dubai (AE)

(21) Appl. No.: 19/640,707

(22) Filed: Apr. 7, 2026

Related U.S. Application Data
(60) Provisional application No. 63/785,451, filed on Apr. 8, 2025.

(51) Int. Cl. B25H 3/00

(52) U.S. Cl. CPC B25H 3/003

(57) ABSTRACT

A case assembly includes an outer case including an outer case opening and defining an outer case end aperture, an inner case to be inserted through the outer case end aperture, and an endcap assembly. The endcap assembly includes an endcap plate, a plug, and a button assembly. The plug protrudes from the endcap plate and is configured to be received within the outer case end. The plug includes a first plug wall and a second plug wall, where the first plug wall has a first plug wall opening. The button assembly includes a button assembly coil disposed between the first plug wall and the second plug wall and a pin. The pin includes a first pin portion extending through the first plug wall opening, a second pin portion extending into the button assembly coil, and a third pin portion to be received within the outer case opening.

### CROSS-REFERENCE TO RELATED PATENT APPLICATION

This application claims priority to U.S. Provisional Patent Application No. 63/785,451, filed Apr. 8, 2025, the disclosure of which is incorporated herein by reference in its entirety for all purposes.

### TECHNICAL FIELD

The present disclosure relates generally to systems and methods for a case or a case assembly for holding and storing objects, such as tools.

### BACKGROUND

A conventional case assembly for storing tools may include multiple trays to secure the tools within the case assembly. Some conventional case assemblies include a hinge or locking mechanism to fold the case assembly into a compact form and a locking mechanism to secure the case in the compact form.

### SUMMARY

One embodiment relates to a case assembly. The case assembly includes an outer case, an inner case, and an endcap assembly. The outer case includes an outer case opening. The outer case defines an outer case end aperture. The inner case is configured to be inserted through the outer case end aperture and positioned within the outer case. The endcap assembly includes an endcap plate, a plug, and a button assembly. The plug protrudes from the endcap plate. The plug is configured to be received within the outer case end aperture while the inner case is positioned within the outer case. The plug includes a first plug wall and a second plug wall, where the first plug wall has a first plug wall opening. The button assembly includes a button assembly coil and a pin. The button assembly coil is disposed between the first plug wall and the second plug wall. The pin includes a first pin portion extending at least partly through the first plug wall opening, a second pin portion extending into at least a portion of the button assembly coil, and a third pin portion configured to be received within the outer case opening when the plug is received within the outer case end aperture.

Another embodiment relates to a case assembly that includes an outer case and an endcap assembly. The outer case includes an outer case opening, and the outer case defines an outer case end aperture. The endcap assembly includes an endcap plate, a plug, a first endcap plate coil, a second endcap plate coil, and a button assembly. The plug is protruding from the endcap plate. The plug is configured to be received within the outer case end aperture while the inner case is positioned within the outer case. The plug includes a first plug wall and a second plug wall, where the first plug wall has a first plug wall opening. The first endcap plate coil is coupled to the endcap plate on a first side of the plug. The first endcap plate coil is configured to be compressed when the plug is received within the outer case end aperture. The second endcap plate coil is coupled to the endcap plate on a second side of the plug, the second side is opposite the first side. The second endcap plate coil is configured to be compressed when the plug is received within the outer case end aperture. The button assembly includes a button assembly coil and a pin. The button assembly coil is disposed between the first plug wall and the second plug wall. The pin includes a first pin portion extending at least partly through the first plug wall opening, a second pin portion extending into at least a portion of the button assembly coil, and a third pin portion configured to be received within the outer case opening when the plug is received within the outer case end aperture.

Still another embodiment relates to a method for operating a case assembly. The method includes receiving, by an outer case, an inner case through an outer case end aperture of the outer case. The outer case includes an outer case opening and the inner case storing a plurality of tools. The method further includes, after receiving the inner case, receiving, by the outer case, an endcap assembly. The endcap assembly includes an endcap plate, a plug, and a button assembly. The plug protrudes from the endcap plate. The plug is configured to be received within the outer case end aperture while the inner case is positioned within the outer case. The plug includes a first plug wall and a second plug wall, where the first plug wall has a first plug wall opening. The button assembly includes a button assembly coil and a pin. The button assembly coil is disposed between the first plug wall and the second plug wall. The pin includes a first pin portion extending at least partly through the first plug wall opening, a second pin portion extending into at least a portion of the button assembly coil, and a third pin portion configured to be received within the outer case opening when the plug is received within the outer case end aperture.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

The disclosure will become more fully understood from the following detailed description, taken in conjunction with the accompanying Figures, in which like reference numerals refer to like elements unless otherwise indicated, in which:

FIG. 1 is an example case assembly for storing objects, such as tools;

FIG. 2 is a perspective view of an example outer case of the case assembly of FIG. 1;

FIG. 3 is a perspective top view of an example inner case of the case assembly of FIG. 1;

FIG. 4 is another perspective bottom view of the inner case of the case assembly of FIG. 1;

FIG. 5 is a perspective view of an example endcap assembly of the case assembly of FIG. 1;

FIG. 6 is a side view of the endcap assembly of FIG. 5;

FIG. 7 is a side view of an example pin of the endcap assembly of FIG. 5;

FIG. 8 is a top view of a portion of the case assembly of FIG. 1;

FIG. 9 is a cross-sectional view of the portion of the case assembly of FIG. 1 taken along plane A-A; and

FIG. 10 depicts an example method for operating the case assembly of FIG. 1.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of a case assembly for storing tools. The various concepts introduced above and discussed in greater detail below may be implemented in any of a number of ways, as the described concepts are not limited to any particular manner of implementation. Examples of specific implementations and applications are provided primarily for illustrative purposes.

A conventional case assembly includes trays to store, organize, and protect various tools (e.g., bits, sockets, etc.) and/or tool drivers (e.g., bit driver, ratchet wrench, screwdrivers, etc.). Each tray includes a series of compartments to hold the tools and/or tool drivers. The compartments provide a groove for the tools and/or tool drivers to rest in. Some of these compartments may not otherwise secure the tools and/or tool drivers within the compartments. As a result, the tools and/or tool drivers may be displaced within a conventional case assembly (e.g., during movement of the conventional case assembly, etc.).

The conventional case assembly may include a series of trays coupled together by a hinge or folding mechanism. The hinge enables the conventional case assembly to be folded into a compact form for ease of transport of the conventional case assembly. The conventional case assembly may also include a locking mechanism (e.g., a latch, slide bolts, snap locks, etc.) to secure the conventional case assembly in the compact form. To access the tools and/or tool drivers from the compact form, a user must unlatch the locking mechanism and unfold the conventional case assembly. As a result, the compartments are moved and the tools and/or tool drivers may become displaced. This displacement disorganizes the conventional case assembly, which is undesirable.

Implementations described herein are related to a case assembly having an outer case, an inner case, and an endcap assembly. The inner case is configured to store tools and/or tool drivers within tool sockets and to be positioned within the outer case. The endcap assembly is configured to secure the inner case within the outer case through the use of a pin (e.g., button, etc.). To access the tools and/or tool drivers, a user may engage or actuate the pin (e.g., press the pin), which enables removal of the endcap assembly from the outer case, remove the endcap assembly from the outer case, and remove the inner case from the outer case. The case assembly described herein facilitates desirable retention of tools and tool drivers while providing expedient access to the stored tools and tool drivers.

Technically and beneficially, the case or case assembly of the present disclosure provides several technical advantages and benefits including protecting and shielding the tools or tool drivers stored therein from environmental damage such as rust and other forms of corrosion. Additionally, the case or case assembly ensures secure storage, preventing the tools and tool drivers from becoming displaced or disorganized within the case, which in turn helps prevent potential damage that could result from such displacement.

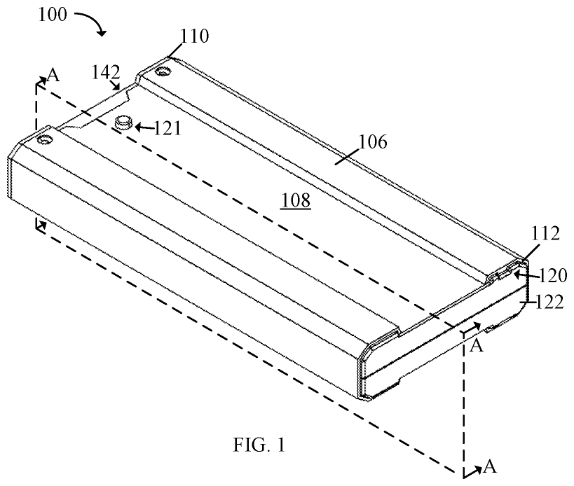

FIG. 1 depicts a case, shown as a case assembly 100 (e.g., case system, etc.). The case assembly 100 may be used to store a plurality of objects, such as tools (e.g., bits, extensions, chucks, etc.). The tools may be utilized by a user (e.g., human, operator, craftsperson, etc.) to perform various tasks. For example, the tools may be utilized by a user to tighten or loosen a component (e.g., bolt, fastener, screw, nut, etc.). In addition to storing the tools, or alternatively to storing the tools, the case assembly 100 may store a tool driver (e.g., bit driver, etc.). For example, the case assembly 100 may store a tool driver and tools for the tool driver. This may be useful, for example, to organize the tool driver and the tools in a portable and protective manner and enable efficient usage of the tool driver. The tool driver may be configured to be coupled to each of the tools such that rotation of the tool driver is transferred to one of the tools. In some applications, the case assembly 100 is provided without any of the tools and without the tool driver (e.g., such that the user may utilize the case assembly 100 with the user's own tools and tool driver, etc.).

The case assembly 100 includes an outer case 106 (e.g., outer member, outer shell, etc.). As is explained in more detail herein, the outer case 106 provides protection, such as to moisture and/or dirt, to other components of the case assembly 100, tools, and/or tool drivers. In this way and due to the protection, in addition to facilitating organization of tools and tool drivers, the outer case 106 facilitates prolonged desirable operation of the tools and tool drivers (e.g., due to reduced corrosion, etc.). The outer case 106 may be formed from (e.g., molded from, etc.) plastic, for example.

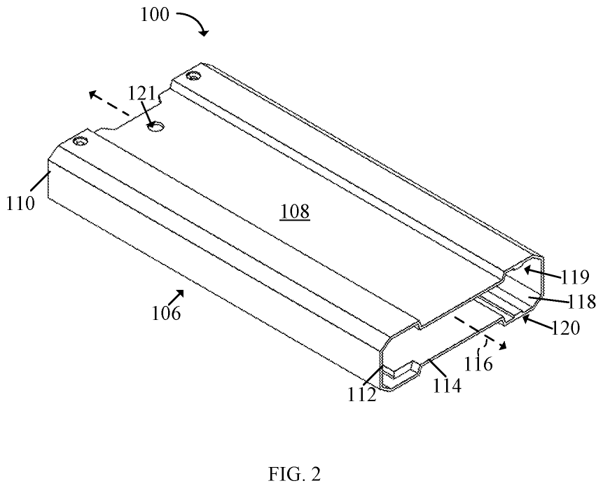

Referring now to FIG. 2, the outer case 106 includes an outer case main body 108. The outer case main body 108 includes a first outer end 110 and a second outer end 112. The first outer end 110 is positioned opposite, and particularly longitudinally opposite, the second outer end 112.

The outer case 106 also includes an outer case end aperture 114 (e.g., opening, etc.). The outer case end aperture 114 extends through the first outer end 110 to the second outer end 112. In various embodiments, the first outer end 110 is open and the second outer end 112 is closed. In other embodiments, the first outer end 110 and the second outer end 112 are both open and the case assembly 100 includes an additional endcap coupled to the second outer end 112 to close the second outer end 112. The outer case end aperture 114 is centered on an outer case axis 116. In other words, the outer case axis 116 extends through a center of the outer case end aperture 114.

The outer case main body 108 also includes an outer case inner surface 118. The outer case inner surface 118 extends around the outer case end aperture 114. The outer case inner surface 118 is proximate the outer case end aperture 114.

The outer case 106 also includes a first outer case rail 119 (e.g., rib, etc.) and a second outer case rail 120. The first outer case rail 119 and the second outer case rail 120 disposed along the outer case inner surface 118. The first outer case rail 119 and the second outer case rail 120 extend inwardly from the outer case inner surface 118 toward the cross-sectional center of the outer case end aperture 114. For example, the first outer case rail 119 and the second outer case rail 120 may extend inwardly from the outer case inner surface 118 into the outer case end aperture 114. The first outer case rail 119 and the second outer case rail 120 may extend substantially parallel to the outer case axis 116 from the first outer end 110 to the second outer end 112. As described herein, the term “substantially parallel” means that the first outer case rail 119 and second outer case rail 120 extends at an angle of −10 degrees to +10 degrees with respect to the outer case axis 116. The same definition (−10 degrees to +10 degrees) similarly applies to other recitations of “substantially parallel” herein.

The outer case 106 includes or defines an outer case opening 121 (e.g., hole, etc.). The outer case opening 121 extends through the outer case main body 108. The outer case opening 121 may be positioned closer to the first outer end 110 than the second outer end 112. For example, the outer case opening 121 may be positioned a first distance away from the first outer end 110 and a second distance away from the second outer end 112. The first distance may be approximately between 1% and 50%, inclusive, of the second distance. The outer case opening 121 may be substantially aligned with the outer case axis 116. In other words, an axis around which the outer case opening 121 extends and on which the outer case opening 121 is centered may intersect the outer case axis 116 and may be substantially perpendicular to the outer case axis 116. As described herein, the term “substantially perpendicular” means that the outer case axis 116 extends at an angle of +80 degrees to +100 degrees with respect to the plane along which outer case opening 121 is disposed. The same definition (+80 degrees to +100 degrees) similarly applies to other recitations of “substantially perpendicular” herein.

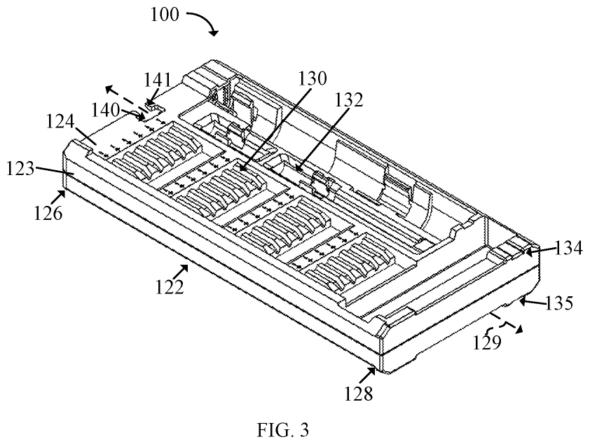

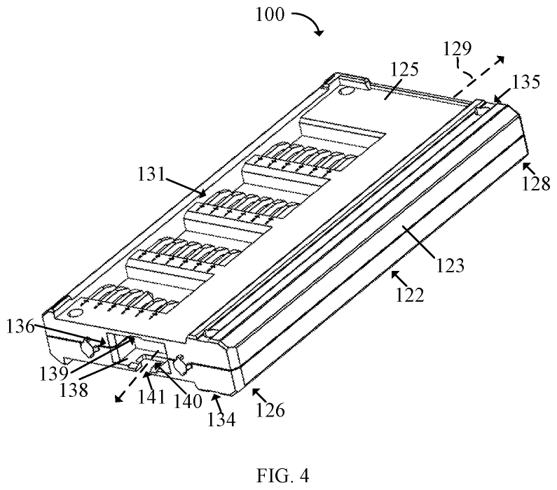

Referring now to FIGS. 3 and 4, the case assembly 100 also includes an inner case 122 (e.g., inner shell, carrier, etc.). The inner case 122 is selectively received within the outer case 106. For example, the inner case 122 is received by the outer case 106 through the outer case end aperture 114. When the inner case 122 is positioned within the outer case 106, the outer case 106 may protect or shield the inner case 122.

The inner case 122 includes an inner case body 123. The inner case body 123 includes a first inner end 126 and a second inner end 128. The first inner end 126 is positioned opposite, and particularly longitudinally opposite, the second inner end 128. When the inner case 122 is positioned within the outer case 106, the first inner end 126 may be substantially aligned with the first outer end 110 and the second inner end 128 may be substantially aligned with the second outer end 112.

The inner case 122 includes a first inner case surface 124 and a second inner case surface 125. Particularly, the inner case body 123 may include the first inner case surface 124 and the second inner case surface 125. The first inner case surface 124 and the second inner case surface 125 extend from the first inner end 126 to the second inner end 128. The first inner case surface 124 is substantially parallel to the second inner case surface 125. As shown in FIGS. 3 and 4, the first inner case surface 124 may represent a top surface of the inner case 122 and the first inner end 126 may represent a bottom surface of the inner case 122, or vice versa.

The inner case 122 is centered on an inner case axis 129. In other words, the inner case axis 129 extends through a center of an end of the inner case 122. The inner case axis 129 may be substantially parallel to a surface upon which the first inner case surface 124 and the second inner case surface 125 extend. The inner case axis 129 may be substantially parallel to the outer case axis 116 when the inner case 122 is positioned within the outer case 106. When the inner case 122 is positioned within the outer case 106, the first inner case surface 124 and the second inner case surface 125 may be in contact with the outer case inner surface 118.

Still referring to FIGS. 3 and 4, the inner case 122 includes a first plurality of sockets 130 (e.g., receptacles, tool sockets, etc.) and a second plurality of sockets 131. The first plurality of sockets 130 are defined by and disposed along the first inner case surface 124. The second plurality of sockets 131 are defined by and disposed along the second inner case surface 125. Each socket of the first plurality of sockets 130 and the second plurality of sockets 131 is configured to selectively receive a tool. For example, each socket of the first plurality of sockets 130 and the second plurality of sockets 131 may include a groove and at least one protrusion (e.g., prong, etc.) within the groove that deflects outwards to enable retaining of a tool within the groove of the socket. In another example, each tool in a plurality of tools may be disposed within a respective one of the first plurality of sockets 130 or the second plurality of sockets 131.

In various embodiments, the inner case 122 also includes a driver receptacle 132. The driver receptacle 132 is configured to selectively receive a tool driver. For example, the driver receptacle 132 may include a groove and at least one protrusion within the groove that deflects outwards to enable retaining of the tool driver within the driver receptacle 132. The driver receptacle 132 may be arranged alongside the first plurality of sockets 130. For example, the first plurality of sockets 130 and the driver receptacle 132 may both be disposed along the first inner case surface 124. The inner case 122, along with any tools and tool drivers stored therein, may be inserted through the outer case end aperture 114 and positioned within the outer case 106.

The inner case 122 includes a first inner case groove 134 (e.g., recess, indentation, etc.) and a second inner case groove 135. The first inner case groove 134 is disposed along the first inner case surface 124 and the second inner case groove 135 is disposed along the second inner case surface 125. The first inner case groove 134 extends inward from the first inner case surface 124 and the second inner case groove 135 extends inward from the second inner case surface 125. Both the first inner case groove 134 and the second inner case groove 135 may extend substantially parallel to the inner case axis 129 from the first inner end 126 to the second inner end 128.

The first inner case groove 134 is configured to receive the first outer case rail 119 and the second inner case groove 135 is configured to receive the second outer case rail 120. For example, as the outer case end aperture 114 receives the inner case 122, the first inner case groove 134 receives the first outer case rail 119 and the second inner case groove 135 receives the second outer case rail 120. The first inner case groove 134 and the second inner case groove 135 assist in guiding the inner case 122 to be positioned within the outer case 106. Similarly, the first inner case groove 134 and the second inner case groove 135 also provide a secure placement of the inner case 122 within outer case 106. This secure placement mitigates displacement of tools and tool drivers within the outer case 106.

Referring now to FIG. 4, the inner case 122 includes an inner case receptacle 136 (e.g., opening, etc.). The inner case receptacle 136 extends inward from the inner case body 123. The inner case axis 129 may be substantially parallel to a plane along which the inner case receptacle 136 is disposed.

The inner case receptacle 136 includes a first inner case wall 138 and a second inner case wall 139. The first inner case wall 138 and the second inner case wall 139 define the inner case receptacle 136. The first inner case wall 138 is parallel to the second inner case wall 139. The inner case axis 129 is substantially parallel to a plane along which the first inner case wall 138 and the second inner case wall 139 are disposed.

The inner case receptacle 136 includes an inner case wall opening 140 (e.g., aperture, etc.). The inner case wall opening 140 is disposed along the first inner case wall 138. The inner case wall opening 140 extends through the first inner case wall 138 and the first inner case surface 124. The inner case wall opening 140 extends substantially perpendicular to the inner case axis 129.

The inner case receptacle 136 includes an inner case wall slot 141. The inner case wall slot 141 extends through the first inner case wall 138 and the first inner case surface 124. The inner case wall slot 141 extends from the inner case wall opening 140 to an edge of the first inner case surface 124. The inner case wall slot 141 can include a width that is less than the width of the inner case wall opening 140. The difference in widths can allow a third pin portion 170 of a pin 164, but not a wing 172 of the pin 164, as described below, to traverse through the inner case wall slot 141. While the third pin portion 170 and the wing 172 of the pin 164 can extend through the inner case wall opening 140 after the third pin portion 170 traverses through the inner case wall slot 141.

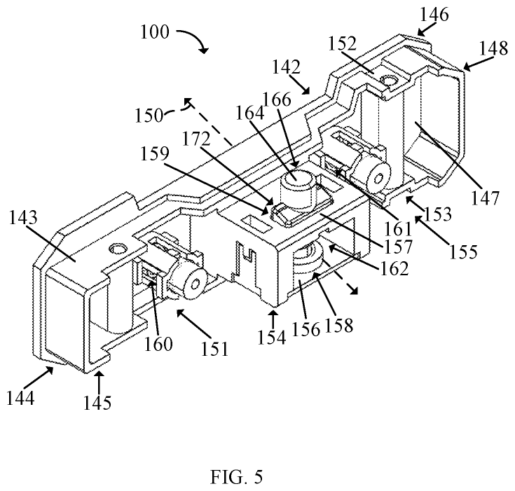

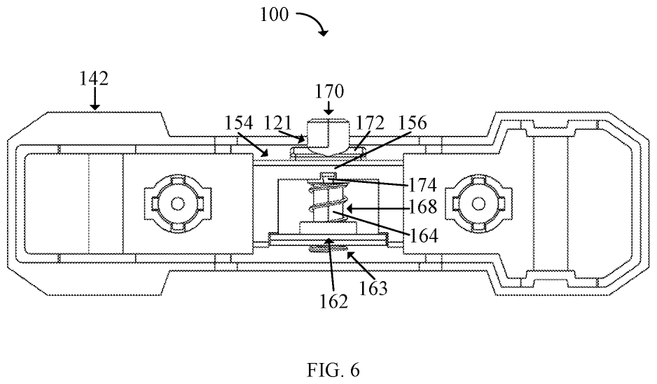

Referring now to FIGS. 5 and 6, the case assembly 100 also includes an endcap assembly 142 (e.g., cap, cover, closure, etc.). As is explained in more detail herein, the endcap assembly 142 is selectively coupled to the outer case 106 to fix the inner case 122 within the outer case 106. For example, the inner case 122 is first received by the outer case 106 and then the endcap assembly 142 is coupled to the outer case 106. Upon the endcap assembly 142 coupling with the outer case 106, the inner case 122 is fixed within the outer case 106 and cannot be removed until the endcap assembly 142 is decoupled from the outer case 106. This may be useful, for example, to ensure the inner case 122 as well as the tools and tool drivers stored therein do not separate from the outer case 106.

The endcap assembly 142 includes an endcap plate 144. The endcap assembly 142 also includes an endcap axis 150. The endcap plate 144 is centered on the endcap axis 150. When the endcap assembly 142 is coupled to the outer case 106 and the inner case 122, the endcap plate 144 may be substantially perpendicular to the outer case axis 116 and may at least partially cover an end of the outer case end aperture 114.

The endcap plate 144 includes a first endcap end 146 and a second endcap end 148. The endcap plate 144 may extend substantially parallel to the endcap axis 150 from the first endcap end 146 to the second endcap end 148. The endcap axis 150 may be substantially parallel to the outer case axis 116 and the inner case axis 129 when the endcap assembly 142 is coupled to the outer case 106 and the inner case 122.

The endcap plate 144 includes a first endcap surface 143 and a second endcap surface 145. The first endcap surface 143 is substantially parallel to the second endcap surface 145. The first endcap surface 143 and the second endcap surface 145 extends from the first endcap end 146 to the second endcap end 148. The endcap plate 144 includes a third endcap surface 147. The third endcap surface 147 is substantially perpendicular to the first endcap surface 143 and the second endcap surface 145.

The endcap assembly 142 includes a first endcap groove 152 (e.g., recess, indentation, etc.) and a second endcap groove 153. Specifically, the endcap plate 144 includes the first endcap groove 152 and the second endcap groove 153. The first endcap groove 152 is disposed along the first endcap surface 143. The second endcap groove 153 is disposed along the second endcap surface 145. The first endcap groove 152 extends inward from the first endcap surface 143 and the second endcap groove 153 extends inward from the second endcap surface 145. Both the first endcap groove 152 and the second endcap groove 153 may extend substantially parallel to the endcap axis 150 from the first endcap end 146 to the second endcap end 148.

The first endcap groove 152 is configured to receive the first outer case rail 119 and the second endcap groove 153 is configured to receive the second outer case rail 120. For example, as the outer case end aperture 114 receives the endcap assembly 142, the first endcap groove 152 receives the first outer case rail 119 and the second endcap groove 153 receives the second outer case rail 120. The first endcap groove 152 and the second endcap groove 153 assist in guiding the endcap assembly 142 to be positioned within the outer case 106. Similarly, the first endcap groove 152 and the second endcap prove also provide a secure placement of the endcap assembly 142 within the outer case 106, preventing the inner case 122 from becoming displaced within the outer case 106.

The endcap plate 144 includes a plug 154 (e.g., protrusion, etc.). For example, the plug 154 protrudes from the endcap plate 144. Specifically, the plug 154 extends from the third endcap surface 147 of the endcap plate 144. For example, the plug 154 extends outward from the third endcap surface 147 along the endcap axis 150. The plug 154 extending outward from the third endcap surface 147 enables the plug 154 to be received by the inner case receptacle 136 and enables the endcap assembly 142 to be positioned within the inner case 122 and the outer case 106. The plug 154 extending outward from the third endcap surface 147 defines a first side of the plug 151 and a second side of the plug 155. The first side of the plug 151 includes the area of the endcap plate 144 to the left of the plug 154 and the second side of the plug 155 include the area of the endcap plate 144 to the right of the plug 154. The first side of the plug 151 is opposite the second side of the plug 155.

The plug 154 includes a first plug wall 156 and a second plug wall 157. The first plug wall 156 and the second plug wall 157 extend outward from the third endcap surface 147. The first plug wall 156 is substantially parallel to the second plug wall 157. Both the first plug wall 156 and the second plug wall 157 are substantially parallel to the endcap axis 150. The first plug wall 156 includes a first plug wall opening 158 (e.g., aperture, etc.) and the second plug wall 157 includes a second plug wall opening 159. The first plug wall opening 158 extends through the first plug wall 156 and the second plug wall opening 159 extends through the second plug wall 157. The first plug wall opening 158 is aligned with the second plug wall opening 159.

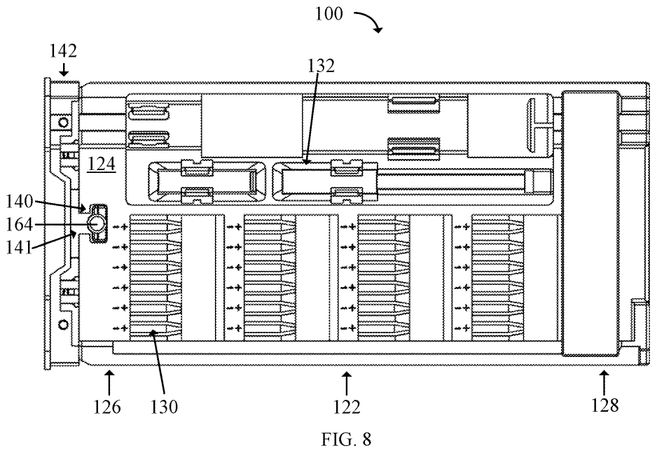

Now referring to FIG. 8, the plug 154 is configured to be received within the outer case end aperture 114 while the inner case 122 is positioned within the outer case 106. After the inner case 122 is received within the outer case 106, the endcap assembly 142 is received by the outer case end aperture 114 such that the plug 154 is received by the inner case receptacle 136 within the outer case end aperture 114.

When the plug 154 is received within the inner case receptacle 136, the first plug wall 156 and the second plug wall 157 may be substantially parallel to the first inner case wall 138 and the second inner case wall 139. For example, the first plug wall 156 and the second plug wall 157 may rest between the first inner case wall 138 and the second inner case wall 139. The inner case wall opening 140 may be substantially aligned with the first plug wall opening 158 and the second plug wall opening 159.

Now referring to FIGS. 5 and 6, the endcap assembly 142 includes a first endcap plate coil 160 (e.g., spring, etc.) and a second endcap plate coil 161. The first endcap plate coil 160 and the second endcap plate coil 161 both extend from and are coupled to the third endcap surface 147 of the endcap plate 144. For example, the first endcap plate coil 160 is coupled to the endcap plate 144 on the first side of the plug 151 and the second endcap plate coil 161 is coupled to the endcap plate 144 on the second side of the plug 155.

Both the first endcap plate coil 160 and the second endcap plate coil 161 are configured to be compressed by the inner case 122. For example, when the inner case 122 is positioned within the outer case 106, and as the plug 154 is received within the inner case receptacle 136, the first endcap plate coil 160 and the second endcap plate coil 161 come in contact with the inner case 122. As a result, the first endcap plate coil 160 and the second endcap plate coil 161 compress and apply a force to the inner case 122 and the endcap assembly 142.

The endcap assembly 142 includes a button assembly 162. The button assembly 162 is configured to selectively couple the endcap assembly 142 with the outer case 106 and the inner case 122.

The button assembly 162 includes a button assembly coil 163 (e.g., spring). The button assembly coil 163 is disposed between the first plug wall 156 and the second plug wall 157. The button assembly coil 163 is configured between the first plug wall 156 and the second plug wall 157 such that the button assembly coil 163 compresses and returns to a neutral state while remaining disposed therein. In various embodiments, as described herein, the button assembly coil 163 may extend at least partially through the first plug wall opening 158 or the second plug wall opening 159.

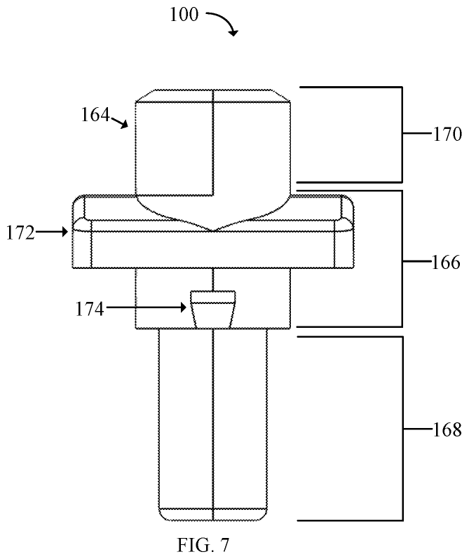

Referring now to FIG. 7, the button assembly 162 includes a pin 164. The pin 164 is disposed at least partially within the plug 154. For example, the pin 164 is disposed at least partially between the first plug wall 156 and the second plug wall 157. The pin 164 extends at least partially through the first plug wall opening 158. The pin 164 may extend at least partially through the second plug wall opening 159.

A user may interact with the pin 164. For example, the user may apply a force to (e.g., press, etc.) the pin 164 causing pin 164 to lower within the first plug wall opening 158 and extend at least partially through the second plug wall opening 159.

The pin 164 extends at least partially through the button assembly coil 163 (e.g., coil). The pin 164 is configured to compress the button assembly coil 163. As the user applies a force to the pin 164, the pin 164 lowers within the first plug wall opening 158 through the second plug wall opening 159 and applies pressure to the button assembly coil 163, causing the button assembly coil 163 to compress toward the second plug wall opening 159. When a force is no longer applied to the pin 164, the button assembly coil 163 decompresses, causing the pin 164 to ascend through the first plug wall opening 158 and to no longer extend through the second plug wall opening 159.

The pin 164 includes a plurality of portions. The first pin portion 166 extends at least partly through the first plug wall opening 158. For example, at least part of, but not the entirety of, the first pin portion 166 extends through the first plug wall opening 158. The second pin portion 168 is the part of pin 164 that extends into at least a portion of the button assembly coil 163. The second pin portion 168 may extend at least partially through the second plug wall opening 159. For example, as the user applies a force to the pin 164, the second pin portion 168 may extend at least partially through the second plug wall opening 159.

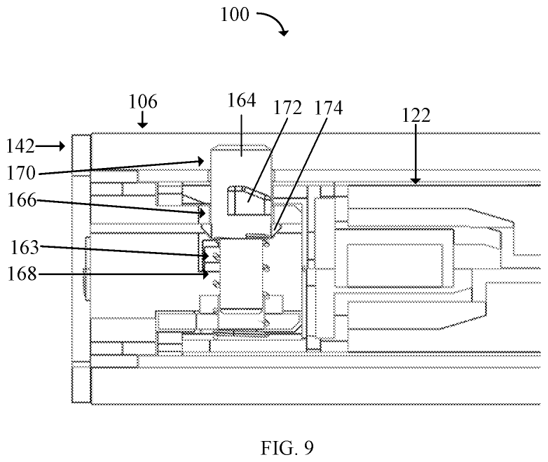

Now referring to FIG. 9, the third pin portion 170 is the part of pin 164 that extends above the first pin portion 166. The third pin portion 170 is configured to be received within the inner case wall opening 140. For example, the third pin portion 170 is configured to traverse through the inner case wall slot 141 to be positioned within the inner case wall opening 140. The third pin portion 170 is further configured to be received within the outer case opening 121 when the endcap assembly 142 is received within the outer case 106.

The pin 164 includes a wing 172 (e.g., protrusion, etc.). The wing 172 extends from the pin 164 between the first pin portion 166 and the second pin portion 168. The wing 172 includes a width less than the width of the inner case wall opening 140 but greater than the width of the inner case wall slot 141. The wing 172 protrudes from the plug 154. For example, when no force is applied to the pin 164, the wing 172 may rest above the first plug wall 156 and the first plug wall opening 158, such that the wing 172 the entirety of or a significate portion of the wing 172 protrudes above the first plug wall 156. The wing 172 may lower (e.g., retract) through the first plug wall opening 158. For example, when the force is applied to the pin 164, the wing 172 and the pin 164 may lower through the first plug wall opening 158. Accordingly, the wing 172 may be enclosed within the plug 154. For example, the wing 172 may be positioned below the first plug wall opening 158 such that none of the wing 172 extends above the first plug wall opening 158.

Upon the outer case 106 receiving the endcap assembly 142, the wing 172 can extend through the first plug wall opening 158 and the inner case wall opening 140. For example, the wing 172 can enter the first plug wall opening 158 and the inner case wall opening 140 such that the wing 172 extends at least partially above the first plug wall opening 158 and the inner case wall opening 140.

The pin 164 includes a ridge 174. The ridge 174 extends from the pin 164 between the wing 172 and the second pin portion 168. The ridge 174 contacts the button assembly coil 163 and is configured to retain the button assembly coil 163 relative to the first pin portion 166. The ridge 174 is configured to compress the button assembly coil 163. For example, when a user applies a force to the pin 164 causing the pin 164 to lower through the first plug wall opening 158, the ridge 174 applies a force to the button assembly coil 163 causing the button assembly coil 163 to compress.

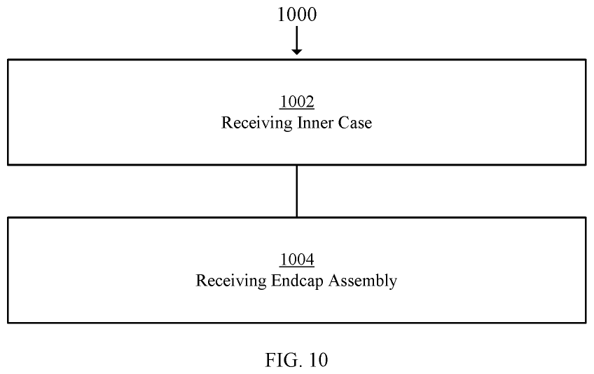

FIG. 10 depicts a method 1000 for operating the case assembly 100. The method 1000 includes the outer case 106 receiving the inner case 122 at step 1002. For example, the outer case end aperture 114 receives the inner case 122 such that the first outer case rail 119 receives the first inner case groove 134 and the second outer case rail 120 receives the second inner case groove 135, positioning the inner case 122 within the outer case 106. The inner case 122 may be received within the outer case 106 such that the inner case receptacle 136 faces outward toward the first outer end 110 of the outer case 106.

The method 1000 includes the outer case 106 receiving the endcap assembly 142 at step 1004. For example, the outer case end aperture 114 receives the endcap assembly 142 such that the first outer case rail 119 receives the first endcap groove 152 and the second outer case rail 120 receives the second endcap groove 153. As the outer case end aperture 114 receives the endcap assembly 142, the inner case receptacle 136 receives the plug 154 such that the first plug wall 156 and the second plug wall 157 is positioned between the first inner case wall 138 and the second inner case wall 139.

As the inner case receptacle 136 receives the plug 154, the wing 172 of the pin 164 comes into contact with the first inner case wall 138 of the inner case 122 compressing the button assembly coil 163. After bringing the wing 172 into contact with the first inner case wall 138, the endcap assembly 142 is inserted into the outer case 106. As the force is applied to the pin 164, the pin 164 lowers within the first plug wall opening 158 and extends at least partially through the second plug wall opening 159. For example, the force applied to the third pin portion 170 causes the second pin portion 168 to extend at least partially through the second plug wall opening 159. Simultaneously causing the wing 172 to enter the first plug wall opening 158 and the ridge 174 to compress the button assembly coil 163. Applying the force to the pin 164 prevents the pin 164 from contacting the outer case main body 108 as the outer case 106 receives the endcap assembly 142.

The inner case 122 positioned within the outer case 106 then receives the endcap assembly 142. As the pin 164 is lowered within the first plug wall opening 158, the pin 164 traverses through the inner case wall slot 141 to the inner case wall opening 140. Due to the wing 172 including a width less than the width of the inner case wall opening 140 but greater than the width of the inner case wall slot, the inner case wall slot 141 prevents the wing 172 from traversing through the inner case wall slot 141 after the pin 164 is received by the inner case wall opening 140.

The pin 164 then enters the outer case opening 121 such that the outer case opening 121 receives the pin 164. For example, the pressure of the button assembly coil 163 being compressed causes the third pin portion 170 to extend at least partially through the outer case opening 121. As such, the pin 164 extends through the outer case opening 121, the inner case wall opening 140, and the first plug wall opening 158. The wing 172 rests between the outer case inner surface 118 and the second inner case wall 139 above the inner case wall opening 140. The ridge 174 rests between the first plug wall 156 and the second plug wall 157. The wing 172 is configured to prevent the third pin portion 170 from extending too far through the outer case opening 121.

As the inner case 122 receives the endcap assembly 142, the first endcap plate coil 160 and the second endcap plate coil 161 contact the inner case 122, compressing the first endcap plate coil 160 and the second endcap plate coil 161, and applying a force to the inner case 122 and the endcap assembly 142.

The endcap assembly 142 may then be removed from the outer case 106. A user may apply a force to the third pin portion 170 of the pin 164 to decouple the endcap assembly 142 from the outer case 106. As a result of the force, the third pin portion 170 lowers completely through the outer case opening 121. The pin 164 also lowers, although not completely, through the inner case wall opening 140, the first plug wall opening 158, and extends at least partially through the second plug wall opening 159. As the pin 164 lowers, the ridge 174 compresses the button assembly coil 163.

Once the pin 164 no longer extends through the outer case opening 121, the force applied to the inner case 122 and the endcap assembly 142 by the first endcap plate coil 160 and the second endcap plate coil 161 results in the endcap assembly 142 traversing along the first outer case rail 119 and the second outer case rail 120 away from the inner case 122. Simultaneously, the pin 164 traverses through the inner case wall slot 141 decoupling the endcap assembly 142 from the outer case 106 and the inner case 122. The inner case 122 may then traverse along the first outer case rail 119 and the second outer case rail 120 to be removed from the outer case 106.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described as acting in certain combinations and even initially claimed as such, one or more features from a claimed combination can, in some cases, be excised from the combination, and the claimed combination may be directed to a sub combination or variation of a sub combination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be in the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components, or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come in the spirit and/or scope of the described implementations are desired to be protected. It should be understood that some features may not be necessary, and implementations lacking the various features may be contemplated as in the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values in the range of values (e.g., W1 to W2 can include only W1 and W2, etc.), unless otherwise indicated.

What is claimed is:

1. A case assembly for storing a plurality of tools, the case assembly comprising:
an outer case comprising an outer case opening, the outer case defining an outer case end aperture;
an inner case configured to be inserted through the outer case end aperture and positioned within the outer case; and
an endcap assembly comprising:
an endcap plate;
a plug protruding from the endcap plate, the plug configured to be received within the outer case end aperture while the inner case is positioned within the outer case, the plug comprising a first plug wall and a second plug wall, the first plug wall having a first plug wall opening; and
a button assembly comprising:
a button assembly coil disposed between the first plug wall and the second plug wall, and
a pin comprising a first pin portion extending at least partly through the first plug wall opening, a second pin portion extending into at least a portion of the button assembly coil, and a third pin portion configured to be received within the outer case opening when the plug is received within the outer case end aperture.

2. The case assembly of claim 1, wherein:
the second plug wall is substantially parallel to the first plug wall;
the second plug wall comprises a second plug wall opening substantially aligned with the first plug wall opening; and
the second pin portion is further configured to extend through the second plug wall opening when the button assembly coil is compressed between the first plug wall and the second plug wall.

3. The case assembly of claim 1, wherein the endcap assembly further comprises:
at least one endcap plate coil coupled to the endcap plate, the at least one endcap plate coil configured to be compressed by the inner case when the plug is received within the outer case end aperture.

4. The case assembly of claim 3, wherein the at least one endcap plate coil comprises:
a first endcap plate coil coupled to the endcap plate on a first side of the plug, the first endcap plate coil configured to be compressed by the inner case when the plug is received within the outer case end aperture; and
a second endcap plate coil coupled to the endcap plate on a second side of the plug, the second side opposite the first side, the second endcap plate coil configured to be compressed by the inner case when the plug is received within the outer case end aperture.

5. The case assembly of claim 1, wherein:
the inner case comprises an inner case receptacle comprising:
a first inner case wall, and
a second inner case wall substantially parallel to the first inner case wall, the first inner case wall having an inner case wall opening;
the inner case receptacle is configured to receive the plug when the plug is received within the outer case end aperture; and
the inner case wall opening is configured to receive the first pin portion when the plug is received within the inner case receptacle.

6. The case assembly of claim 1, wherein the pin further comprises:
a wing extending from the pin between the first pin portion and the second pin portion, the wing protruding from the plug when the plug is not received within the outer case end aperture; and
a ridge extending from the pin between the wing and the second pin portion, the ridge contacting the button assembly coil and retaining the button assembly coil relative to the first pin portion.

7. The case assembly of claim 1, wherein:
the outer case comprises:
an outer case main body having an outer case inner surface extending around the outer case end aperture, and
an outer case rail disposed along the outer case inner surface and extending inwardly from the outer case main body;
the outer case end aperture is centered on an outer case axis; and
the outer case rail extends substantially parallel to the outer case axis from a first outer end of the outer case main body to a second outer end of the outer case main body.

8. The case assembly of claim 7, wherein:
the inner case comprises:
a first inner case surface, and
an inner case groove disposed along the first inner case surface and extending inwardly from the first inner case surface,
the first inner case surface is centered on an inner case axis;
the inner case groove extends substantially parallel to the inner case axis and the outer case axis from a first inner end of the first inner case surface to a second inner end of the first inner case surface; and
the outer case rail is configured to receive the inner case groove.

9. The case assembly of claim 7, wherein:
the endcap assembly comprises:
an endcap groove disposed along the endcap plate and extending inwardly from the endcap plate, and
an endcap axis disposed on the endcap plate;
the endcap groove extends substantially parallel to the endcap axis and the outer case axis from a first endcap end of the endcap plate to a second endcap end of the endcap plate; and
the outer case rail is configured to receive the endcap groove.

10. A case assembly for storing a plurality of tools, the case assembly comprising:
an outer case comprising an outer case opening, the outer case defining an outer case end aperture; and
an endcap assembly comprising:
an endcap plate;
a plug protruding from the endcap plate, the plug configured to be received within the outer case end aperture, the plug comprising a first plug wall and a second plug wall substantially parallel to the first plug wall, the first plug wall having a first plug wall opening;
a first endcap plate coil coupled to the endcap plate on a first side of the plug, the first endcap plate coil configured to be compressed when the plug is received within the outer case end aperture;
a second endcap plate coil coupled to the endcap plate on a second side of the plug, the second side opposite the first side, the second endcap plate coil configured to be compressed when the plug is received within the outer case end aperture; and
a button assembly comprising:
a button assembly coil disposed between the first plug wall and the second plug wall, and
a pin comprising a first pin portion extending at least partly through the first plug wall opening, a second pin portion extending into at least a portion of the button assembly coil, and a third pin portion configured to be received within the outer case opening when the plug is received within the outer case end aperture.

11. The case assembly of claim 10, wherein:
the second plug wall comprises a second plug wall opening substantially aligned with the first plug wall opening; and
the second pin portion is further configured to extend through the second plug wall opening when the button assembly coil is compressed between the first plug wall and the second plug wall.

12. The case assembly of claim 10, further comprising an inner case configured to be inserted through the outer case end aperture and positioned within the outer case.

13. The case assembly of claim 12, wherein:
the inner case comprises an inner case receptacle comprising:
a first inner case wall, and
a second inner case wall substantially parallel to the first inner case wall, the first inner case wall having an inner case wall opening;
the inner case receptacle is configured to receive the plug when the plug is received within the outer case end aperture; and
the inner case wall opening is configured to receive the first pin portion when the plug is received within the inner case receptacle.

14. The case assembly of claim 12, further comprising the plurality of tools;
wherein the inner case comprises a plurality of tool sockets; and
wherein each of the plurality of tools is disposed within a respective one of the plurality of tool sockets.

15. The case assembly of claim 13, wherein:
the pin comprises:
a wing extending from the pin between the first pin portion and the second pin portion, the wing enclosed within the plug when the plug is received within the outer case end aperture, and
a ridge extending from the pin between the wing and the second pin portion, the ridge contacting the button assembly coil and retaining the button assembly coil relative to the first pin portion; and
the wing is configured to contact the first inner case wall so as to compress the button assembly coil within the plug when the inner case wall opening receives the first pin portion.

16. The case assembly of claim 12, wherein:
the outer case comprises:
an outer case main body having an outer case inner surface extending around the outer case end aperture, and
an outer case rail disposed along the outer case inner surface and extending inwardly from the outer case main body;
the outer case end aperture is centered on an outer case axis; and
the outer case rail extends substantially parallel to the outer case axis from a first outer end of the outer case main body to a second outer end of the outer case main body.

17. The case assembly of claim 16, wherein:
the inner case comprises:
a first inner case surface,
an inner case groove disposed along the first inner case surface and extending inwardly from the first inner case surface, and
an inner case axis disposed on the first inner case surface;
the inner case groove extends substantially parallel to the inner case axis and the outer case axis from a first inner end of the first inner case surface to a second inner end of the first inner case surface; and
the outer case rail is configured to receive the inner case groove.

18. The case assembly of claim 16, wherein:
the endcap assembly comprises:
an endcap groove disposed along the endcap plate and extending inwardly from the endcap plate, and
an endcap axis disposed on the endcap plate;
the endcap groove extends substantially parallel to the endcap axis and the outer case axis from a first endcap end of the endcap plate to a second endcap end of the endcap plate; and
the outer case rail is configured to receive the endcap groove.

19. A method of storing a plurality of tools in a case assembly, the method comprising:
receiving, by an outer case, an inner case through an outer case end aperture of the outer case, the outer case comprising an outer case opening, the inner case storing a plurality of tools; and
after receiving the inner case, receiving, by the outer case, an endcap assembly comprising:
an endcap plate;
a plug protruding from the endcap plate, the plug configured to be received within the outer case end aperture while the inner case is positioned within the outer case, the plug comprising a first plug wall and a second plug wall substantially parallel to the first plug wall, the first plug wall having a first plug wall opening; and
a button assembly comprising:
a button assembly coil disposed between the first plug wall and the second plug wall, and
a pin comprising a first pin portion extending at least partly through the first plug wall opening, a second pin portion extending into at least a portion of the button assembly coil, and a third pin portion configured to be received within the outer case opening when the plug is received within the outer case end aperture.

20. The method of claim 19, wherein receiving, by the outer case, the endcap assembly comprises:
bringing a wing of the pin into contact with a first inner case wall of the inner case so as to compress the button assembly coil within the plug; and
after bringing the wing into contact with the first inner case wall, inserting the endcap assembly into the outer case such that the wing enters an inner case wall opening in the first inner case wall and the pin enters the outer case opening.
